(19) United States
(12) Patent Application Publication
(10) Pub. No.: US 2019/0063665 A1
(43) Pub. Date: Feb. 28, 2019

(54) DISPLAY STAND

(71) Applicant: Leonard D. LeCote, Baton Rouge, LA (US)

(72) Inventor: Leonard D. LeCote, Baton Rouge, LA (US)

(21) Appl. No.: 16/116,653

(22) Filed: Aug. 29, 2018

Related U.S. Application Data
(60) Provisional application No. 62/552,929, filed on Aug. 31, 2017.

(51) Int. Cl. F16M 11/04; F16M 11/30; F16M 11/16

(52) U.S. Cl. CPC F16M 11/046; F16M 11/16; F16M 11/30

(57) ABSTRACT

Display stands are disclosed relating to the support of display devices such as televisions and computer monitors. The display stands described may include a pair of elongate telescoping vertical supports and a pair of elongate telescoping horizontal braces. The display stands may also include a variety of locking mechanisms that may be used to position and fix display devices in a preferred position for viewing.

This application claims the benefit of provisional application No. 62/552,929 filed on Aug. 31, 2017 and entitled TV Ladder Stand.

Display stands described herein may be used to securely locate display devices such as televisions in a variety of locations. Certain display stands disclosed herein may be capable of nondestructive and non-marring mounting of display devices.

### BRIEF DESCRIPTION OF THE DRAWINGS

FIG. 1 shows a display stand.

FIG. 2 shows a display stand.

### DETAILED DESCRIPTION

### Example 1

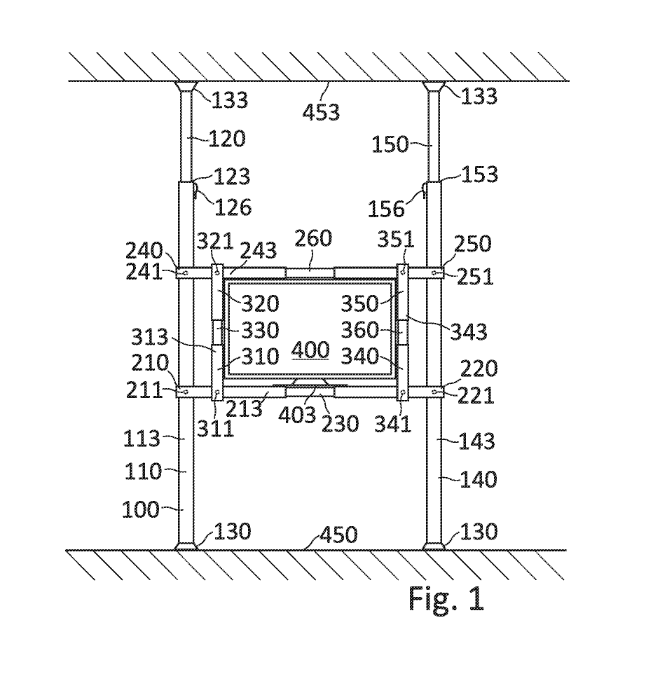

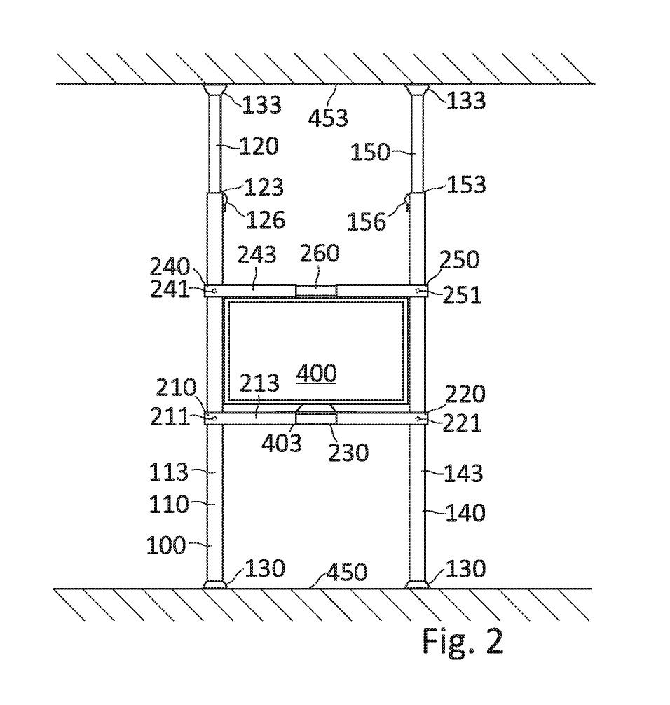

Collectively, FIGS. 1 and 2 depict a Display device stand 100 comprising Left main support 110, Left elongate telescoping vertical support 113, Left ceiling support 120, First sliding joint 123, Pressure lock 126, Base pads 130, Ceiling pads 133, Right main support 140, Right elongate telescoping vertical support 143, Right ceiling support 150, Second sliding joint 153, Pressure lock 156, Lower left horizontal brace 210, Spring button lock 211, Lower elongate telescoping horizontal brace 213, Lower right horizontal brace 220, Spring button lock 221, Lower middle horizontal brace 230, Upper left horizontal brace 240, Spring button lock 241, Upper elongate telescoping horizontal brace 243, Upper right horizontal brace 250, Spring button lock 251, Upper middle horizontal brace 260, Lower left vertical brace 310, Spring button lock 311, Left elongate telescoping vertical brace 313, Upper left vertical brace 320, Spring button lock 321, Middle left vertical brace 330, Lower right vertical brace 340, Spring button lock 341, Right elongate telescoping vertical brace 343, Upper right vertical brace 350, Spring button lock 351, Middle right vertical brace 360, Display device 400 and Display device base 403, Floor 450 and Ceiling 453.

Display device stand 100 may be arranged and configured to securely hold a Display device 400 in a wide variety of locations and circumstances that may be difficult to achieve with other stands. Left ceiling support 120 may be positioned within Left main support 110 such that together Left ceiling support 120 and Left main support 110 form Left elongate telescoping vertical support 113, which is in compression between Floor 450 and Ceiling 453. Right ceiling support 150 may be positioned within Right main support 140 such that together Right ceiling support 150 and Right main support 140 form Right elongate telescoping vertical support 143, which is in compression between Floor 450 and Ceiling 453. Left ceiling support 120 slides into Left main support 110 at First sliding joint 123. Right ceiling support 150 slides into Right main support 140 at Second sliding joint 153. Both Left main support 110 and Right main support 140 have Base pads 130 at their lower ends. Base pads 130 are in contact with Floor 450 and when Display device stand 100 is installed, the Base pads 130 are in compression. Left ceiling support 120 and Right ceiling support 150 have Ceiling pads 133 at their ends. Ceiling pads 133 are in contact with Ceiling 453 and when Display device stand 100 is installed, the Ceiling pads 133 are in compression. Base pads 130 and Ceiling pads 133 may be constructed from rubber or other similar material suitable for a compression and friction based non-marring connection to the floor and ceiling. Lower left horizontal brace 210, Lower right horizontal brace 220 and Lower middle horizontal brace 230 are each horizontally oriented with Lower middle horizontal brace 230 slidably situated within both Lower left horizontal brace 210 and Lower right horizontal brace 220 such that Lower left horizontal brace 210 and Left main support 110 are slidably positionable relative to Right main support 140 and Lower right horizontal brace 220. Together, Lower left horizontal brace 210, Lower right horizontal brace 220, Lower middle horizontal brace 230 form Lower elongate telescoping horizontal brace 213 which may slide vertically as a unit along Left main support 110 and Right main support 140 when not locked in place. Upper left horizontal brace 240, Upper right horizontal brace 250 and Upper middle horizontal brace 260 are each horizontally oriented with Upper middle horizontal brace 260 slidably situated within both Upper left horizontal brace 240 and Upper right horizontal brace 250 such that Upper left horizontal brace 240 and Left main support 110 are slidably positionable relative to Right main support 140 and Upper right horizontal brace 250. Together, Upper left horizontal brace 240, Upper right horizontal brace 250 and Upper middle horizontal brace 260 form Upper elongate telescoping horizontal brace 243. Upper elongate telescoping horizontal brace 243 may slide vertically as a unit along Left main support 110 and Right main support 140 when not locked in place. Lower left horizontal brace 210, Lower right horizontal brace 220, Lower middle horizontal brace 230 may support a Display device 400. Upper left horizontal brace 240, Upper right horizontal brace 250 and Upper middle horizontal brace 260 together may secure the upper end of a Display device 400.

In the embodiment depicted in FIG. 1, Lower left vertical brace 310 and Upper left vertical brace 320 slide over Middle left vertical brace 330 such that the position of Lower left horizontal brace 210 and Upper left horizontal brace 240 may be adjusted relative to one another. Lower right vertical brace 340 and Upper right vertical brace 350 slide over Middle right vertical brace 360 such that the position of Lower right horizontal brace 220 and Upper right horizontal brace 250 may be adjusted relative to one another. Lower left vertical brace 310, Upper left vertical brace 320 and Middle left vertical brace 330 make up Left elongate telescoping vertical brace 313 which may be slid as a unit along Upper left horizontal brace 240 and Lower left horizontal brace 210 to be positioned against the left edge of Display device 400. Lower right vertical brace 340, Upper right vertical brace 350 and Middle right vertical brace 360 make up Right elongate telescoping vertical brace 343 which may be slid as a unit along Lower right horizontal brace 220 and Upper right horizontal brace 250 to be positioned against the right edge of Display device 400. As depicted in FIG. 1, Lower elongate telescoping horizontal brace 213, Upper elongate telescoping horizontal brace 243, Left elongate telescoping vertical brace 313 and Right elongate telescoping vertical brace 343 securely hold Display device 400 against movement in any direction when each sliding component is locked in place. Similarly, As depicted in FIG. 2, Lower elongate telescoping horizontal brace 213, Upper elongate telescoping horizontal brace 243, Left elongate telescoping vertical support 113 and Right elongate telescoping vertical support 143 securely hold Display device 400 against movement in any direction when each sliding component is locked in place. Each sliding component may be locked in place by one of many types of locking mechanisms. A variety of locking mechanisms may be used to fix the components in position relative to one another. Pressure lock 126 and Pressure lock 156 may be locks that create or enhance pressure as they lock in a manner similar to load locks used to secure loads in the trucking and transportation industries. For example, when Left main support 110 is placed in the desired position for installation and Left ceiling support 120 is pressed so that Ceiling pads 133 are firmly against Ceiling 453, Pressure lock 126 may be engaged both increasing the force with which Ceiling pads 133 are pressed against Ceiling 453 and locking Left ceiling support 120 in position relative to Left main support 110. Pressure lock 156 may lock in a manner similar to Pressure lock 126. Lower elongate telescoping horizontal brace 213 and Upper elongate telescoping horizontal brace 243 may be locked in place by Spring button lock 211, Spring button lock 221, Spring button lock 241 and Spring button lock 251. Those spring button locks may be the type of spring button locks that are more commonly used in adjustable telescoping tube applications where spring loaded button passes through two holes that are aligned locking those holes in position relative to one another. As depicted in FIG. 1, Spring button lock 311, Spring button lock 321, Spring button lock 341 and Spring button lock 351 may be used to secure Left elongate telescoping vertical brace 313 and Right elongate telescoping vertical brace 343 in position along Lower elongate telescoping horizontal brace 213 and Upper elongate telescoping horizontal brace 243. Spring button locks may be positioned on the rear of facing side of Display device stand 100 so as not to detract from the aesthetic appearance of Display device stand 100. A variety of other types of locks may be used in the securing of components relative to one another. Display device base 403 may optionally be included as a part of Display device 400.

Various components may be spring loaded relative to one another for the purposes of aiding in the installation of Display device stand 100. For example, Left main support 110 may contain a spring that aids in positioning Left ceiling support 120 adjacent to Ceiling 453. Similarly, Right main support 140 may contain a spring that aids in positioning Right ceiling support 150 adjacent to Ceiling 453.

Display device stand 100 may be constructed predominantly from square or rectangular tubing. For example, Left main support 110 and Right main support 140 may be constructed from 2″×4″ rectangular tubing. A variety of materials may be used to construct Display device stand 100. For example, Display device stand 100 may be wood, plastic or metal. Polyvinylchloride plastics or other similar plastics may be used in the construction of Display device stand 100. Steel and aluminum may also be used.

### Example 2

Display device stand 100 may be assembled by sliding Lower left horizontal brace 210 and Upper left horizontal brace 240 over Left main support 110. Lower right horizontal brace 220 and Upper right horizontal brace 250 may then be slid over Right main support 140. Lower left vertical brace 310 may be slid over Lower left horizontal brace 210, Upper left vertical brace 320 may be slid over Upper left horizontal brace 240, Upper right vertical brace 350 may be slid over Upper right horizontal brace 250 and Lower right vertical brace 340 may be slid over Lower right horizontal brace 220. Next, each of Lower middle horizontal brace 230, Upper middle horizontal brace 260, Middle left vertical brace 330 and Middle right vertical brace 360 may be situated within the other described components as depicted in FIG. 1. For the embodiment depicted in FIG. 2, steps related to Left elongate telescoping vertical brace 313 and Right elongate telescoping vertical brace 343 may be omitted. Left ceiling support 120 may then be placed within Left main support 110 and Right ceiling support 150 may be placed within Right main support 140. Left main support 110 and Right main support 140 may then be oriented vertically while resting on Floor 450. Left main support 110 and Right main support 140 may then be positioned at the ultimate desired location for Display device stand 100. While keeping Left main support 110 and Right main support 140 in a vertical orientation, Left ceiling support 120 and Right ceiling support 150 may be extended until Ceiling pads 133 engage with Ceiling 453 with sufficient pressure to fix the location of Display device stand 100. Left main support 110 may then be locked in position relative to Left ceiling support 120 at First sliding joint 123 using Pressure lock 126 and Right main support 140 may be locked in position relative to Right ceiling support 150 at Second sliding joint 153 using Pressure lock 156. Lower left horizontal brace 210, Lower right horizontal brace 220 and Lower middle horizontal brace 230 may then be placed at a height suitable for viewing Display device 400 at which point Lower left horizontal brace 210 may be locked in position relative to Left main support 110 and Lower right horizontal brace 220 may be locked in position relative to Right main support 140. Display device 400 may then be positioned atop Lower elongate telescoping horizontal brace 213 at the desired viewing position. Upper elongate telescoping horizontal brace 243 may then be pressed against Display device 400 with adequate pressure to secure Display device 400 in position. Then, Upper left horizontal brace 240 may be locked in position along Left main support 110 and Upper right horizontal brace 250 may be locked in position along Right main support 140. In the embodiment shown in FIG. 1, Left elongate telescoping vertical brace 313 may similarly be secured against Display device 400 and locked in position followed by Right elongate telescoping vertical brace 343 being secured against Display device 400 and locked in position.

The display stand may be particularly suited to securely holding a flat screen television without putting holes in the wall. The parts of the display stand may be broken down for storage purposes. Further, the adjustable nature of the display stand allows for variations is the size of displays that may be accommodated and further allows for variations in the aspect ratio that may be accommodated.

Any of the telescoping components that come into contact with Display device 400 may be configured to have one or more lips or other components which serve to engage Display device 400 in a manner that prevents Display device 400 from either falling forward or falling backward out of Display device stand 100. For example, Upper elongate telescoping horizontal brace 243 may have a front lip that projects slightly in front of the uppermost portion of Display device 400 and a rear lip that projects slightly behind the uppermost portion of Display device 400 such that Display device 400 is restrained within Display device stand 100. Alternatively, various other types of clamps and grips may be used in a similar fashion.

The display stand may be configured to hold a display device with a display device diagonal screen measurement that may, for example, be 38.0 inches with certain examples falling between 20.0 and 70.0 inches and a significant number of those examples falling between 29.0 and 54.0 inches.

The display stand minimum vertical extension height may, for example, be 6.0 feet with certain examples falling between 4.0 and 7.0 feet and a significant number of those examples falling between 5.0 and 6.5 feet.

The display stand maximum vertical extension height may, for example, be 10.0 feet with certain examples falling between 7.0 and 12.0 feet and a significant number of those examples falling between 7.5 and 11.0 feet.

The elongate telescoping vertical support depth may, for example, be 3.5 inches with certain examples falling between 2.0 and 8.0 inches and a significant number of those examples falling between 2.8 and 5.8 inches.

Further, smaller versions of the display stand may be constructed to accommodate smaller areas for display including the insides of vehicles and smaller spaces within apartments and other residences.

Display stands described herein may, for example, comprise a first elongate telescoping vertical support; a second elongate telescoping vertical support; a first elongate telescoping horizontal brace; a second elongate telescoping horizontal brace; a first locking mechanism configured to fix the length of the first elongate telescoping vertical support; a second locking mechanism configured to fix the length of the second elongate telescoping vertical support; a third locking mechanism configured to secure the first elongate telescoping horizontal brace to the first elongate telescoping vertical support; a fourth locking mechanism configured to secure the first elongate telescoping horizontal brace to the second elongate telescoping vertical support; a fifth locking mechanism configured to secure the second elongate telescoping horizontal brace to the first elongate telescoping vertical support and a sixth locking mechanism configured to secure the second elongate telescoping horizontal brace to the second elongate telescoping vertical support; such that the first elongate telescoping vertical support and the second elongate telescoping vertical support may be arranged and configured to engage in a pressure attachment to a ceiling and the first elongate telescoping horizontal brace and the second elongate telescoping horizontal brace may be configured to secure a display device between the first elongate telescoping horizontal brace and the second elongate telescoping horizontal brace in a releaseable non-marring attachment. In a related example, the first elongate telescoping vertical support and the second elongate telescoping vertical support may be arranged and configured to engage in a pressure attachment to a floor. In a related example, the display stand may include a plurality of suction cups located at the ends of the first elongate telescoping vertical support and the second elongate telescoping vertical support. In a related example, the display stand may be configured to extend to a total height of eight feet. In a related example, the display stand may be configured to extend to a total height of ten feet. In a related example, the display device may be fixed between first elongate telescoping horizontal brace and the second elongate telescoping vertical support by a pressure attachment. In a related example, the display stand may be freestanding. In a related example, the display may have a total depth of 8 inches or less when the display stand is fully assembled and installed.

As that term is used herein, “telescoping” refers objects that my change length by sliding motion that is predominantly linear. As that phrase is used herein, “display device” indicates a device having a display screen such as a television or computer monitor. As that phrase is used herein, “pressure attachment” indicates an attachment to a surface achieved by some form of pressure against that surface. Examples of pressure attachment include suction cup attachment and compressible pads being pressed against a surface in a manner that resists the compressible pads from sliding along the surface. As that phrase is used herein, “non-marring attachment” indicates an attachment to a surface that is non-destructive. Examples of non-marring attachment include suction cup attachment and compressible pads being pressed against a surface in a manner that resists the compressible pads from sliding along the surface. Nails, screws and other fasteners that typically cause damage to gypsum board are destructive fasteners and not included to be among the attachments that may be considered non-marring attachments.

The above-described embodiments have a number of independently useful individual features that have particular utility when used in combination with one another including combinations of features from embodiments described separately. There are, of course, other alternate embodiments which are obvious from the foregoing descriptions, which are intended to be included within the scope of the present application.

I claim:

1. A display stand comprising:
a. a first elongate telescoping vertical support;
b. a second elongate telescoping vertical support;
c. a first elongate telescoping horizontal brace;
d. a second elongate telescoping horizontal brace;
e. a first locking mechanism configured to fix the length of the first elongate telescoping vertical support;
f. a second locking mechanism configured to fix the length of the second elongate telescoping vertical support;
g. a third locking mechanism configured to secure the first elongate telescoping horizontal brace to the first elongate telescoping vertical support;
h. a fourth locking mechanism configured to secure the first elongate telescoping horizontal brace to the second elongate telescoping vertical support;
i. a fifth locking mechanism configured to secure the second elongate telescoping horizontal brace to the first elongate telescoping vertical support and
j. a sixth locking mechanism configured to secure the second elongate telescoping horizontal brace to the second elongate telescoping vertical support;
k. wherein the first elongate telescoping vertical support and the second elongate telescoping vertical support are arranged and configured to engage in a pressure attachment to a ceiling and
l. wherein the first elongate telescoping horizontal brace and the second elongate telescoping horizontal brace are configured to secure a display device between the first elongate telescoping horizontal brace and the second elongate telescoping horizontal brace in a releaseable non-marring attachment.

2. The display stand of claim 1 wherein the first elongate telescoping vertical support and the second elongate telescoping vertical support are arranged and configured to engage in a pressure attachment to a floor.

3. The display stand of claim 1 further comprising a plurality of suction cups located at the ends of the first elongate telescoping vertical support and the second elongate telescoping vertical support.

4. The display stand of claim 1 wherein the display stand is configured to extend to a total height of eight feet.

5. The display stand of claim 1 wherein the display stand is configured to extend to a total height of ten feet.

6. The display stand of claim 1 wherein the display device is fixed between first elongate telescoping horizontal brace and the second elongate telescoping vertical support by a pressure attachment.

7. The display stand of claim 1 wherein the display stand is freestanding.

8. The display stand of claim 1 wherein the display stand has a total depth of 8 inches or less when the display stand is fully assembled and installed.
